(19) United States
(12) Patent Application Publication
(10) Pub. No.: US 2011/0120033 A1
(43) Pub. Date: May 26, 2011

(54) DOOR JAMB SYSTEM AND METHOD OF INSTALLING SAME

(76) Inventor: Jonathan T. Stetson, Sanbornville, NH (US)

(21) Appl. No.: 12/841,091

(22) Filed: Jul. 21, 2010

Related U.S. Application Data
(60) Provisional application No. 61/227,406, filed on Jul. 21, 2009.

(51) Int. Cl. E06B 1/52; E04C 3/02

(52) U.S. Cl. 52/204.2; 52/745.15

(57) ABSTRACT

The door jamb of the present invention bears a conventional outward appearance, but underneath lies a unique steel exoskeleton which is machined in order to mount it to the home's frame first, then for the door to be mounted to it. This design element harkens back to the days when any carpenter worth his salt would set about the task of installing a door by first constructing a dimensionally perfect opening for it, then hanging the door within the resulting space. The door jamb of the present invention defines this space with the perfect material for the task, which is steel. It is this steel exoskeleton which keeps the door opening within desired tolerances, regardless of outside temperature. This results in much greater latch and lock engagement, as well as significant energy savings from a properly sealed door.

### CROSS-REFERENCE TO RELATED APPLICATION(S)

This application claims the benefit of U.S. Provisional Application No. 61/227406, filed Jul. 21, 2009, which is herein incorporated in its entirety by reference.

### TECHNICAL FIELD

This invention relates to a door jamb. More specifically, the invention relates to a door jamb having a steel skeleton.

### BACKGROUND

In order to accommodate the post World War II building boom in America, door vendors began offering the “pre-hung entry door”. These assemblies have door jambs that are usually made of pine, milled to the proper profile, which is then stapled and glued, more often than not, errantly, to an immovable, captive threshold on the bottom, which attempts to hold the whole thing together. More often than not, these pre-hung door jambs are out of tolerance upon purchase or at installation, and given time, they usually will deviate from desired tolerances, particularly in the corners. Once such a door jamb departs from the allowable tolerances, key functions, such as the ability to open and close the door, proper latching of the lockset to the strike plate and/or sufficient engagement of the deadbolt, often fail to perform or require some form of operator assistance. This is the result of pine being the major structural material. The conventional door jamb not only fails to function well, it also fails to protect the occupants behind the door in any meaningful way.

### SUMMARY

This invention overcomes the disadvantages of the prior art by providing a door jamb having a composite design, its principal structural members are steel and extruded and machined PVC lumber stock, all assembled with stainless steel fasteners.

The door jamb of the present invention bears a conventional outward appearance, but underneath lies a unique steel exoskeleton which is machined in order to mount it to the home's frame first, then for the door to be mounted to it. This design element harkens back to the days when any carpenter worth his salt would set about the task of installing a door by first constructing a dimensionally perfect opening for it, then hanging the door within the resulting space. The door jamb of the present invention defines this space with the perfect material for the task, which is steel. It is this steel exoskeleton which keeps the door opening within desired tolerances, regardless of outside temperature. This results in much greater latch and lock engagement, as well as significant energy savings from a properly sealed door.

Another benefit of the steel exoskeleton is that the threshold now becomes a serviceable component because the lower dimension and structural integrity of the door jamb of the present invention are rendered not by the threshold, but instead by its own sill crossmember/threshold receiver component. Replacing the threshold is accomplished simply by removing three screws, sliding the old one out, and sliding a new one in, while applying silicone caulking simultaneously.

In keeping with its design intent, the kits for the door jamb system of the present invention include only premium quality hinges and thresholds.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention description below refers to the accompanying drawings, of which:

FIG. 1 is a front view of the present invention;

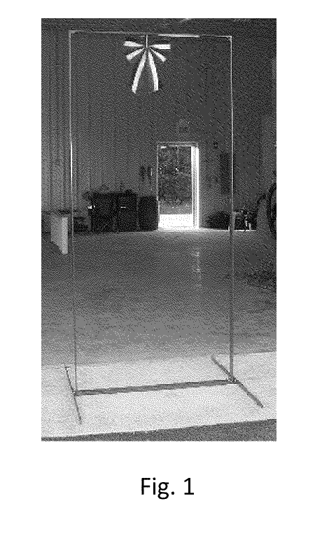

FIG. 2 is a perspective view thereof;

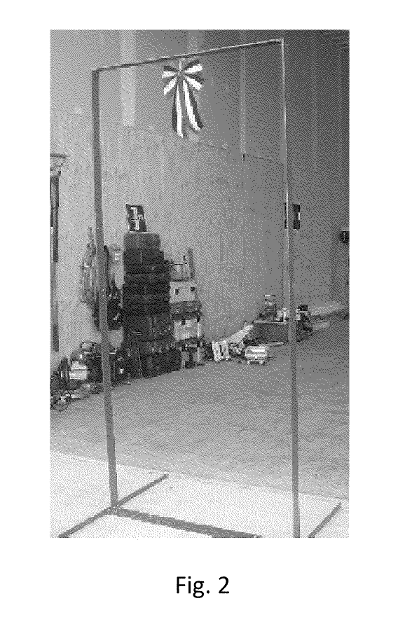

FIG. 3 is a close up view of a corner joint of the present invention;

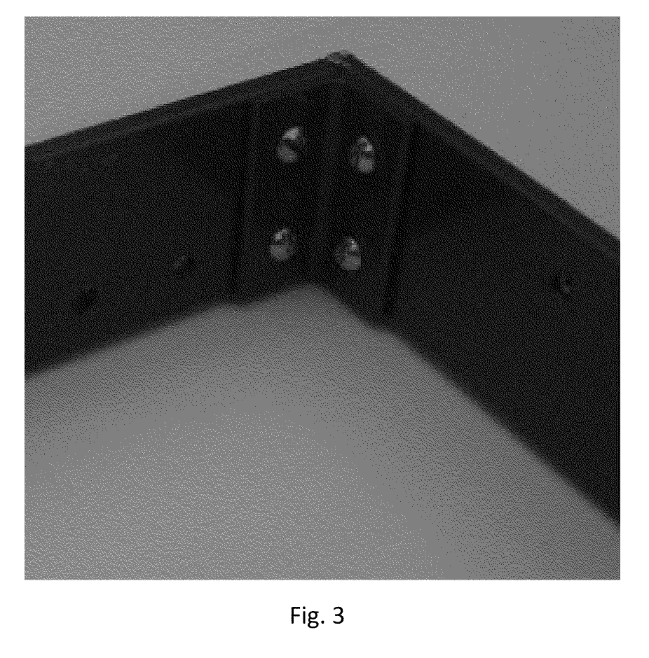

FIG. 4 is a close up view of a corner connector of the present invention;

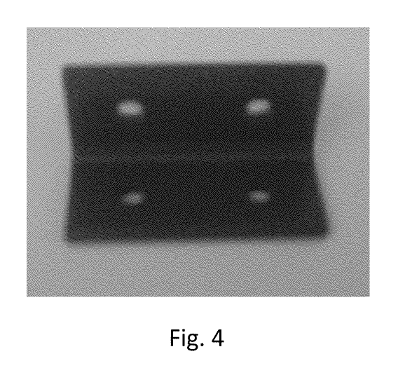

FIG. 5 is a close up view of the exoskeleton of the present invention inserted into an appliqué;

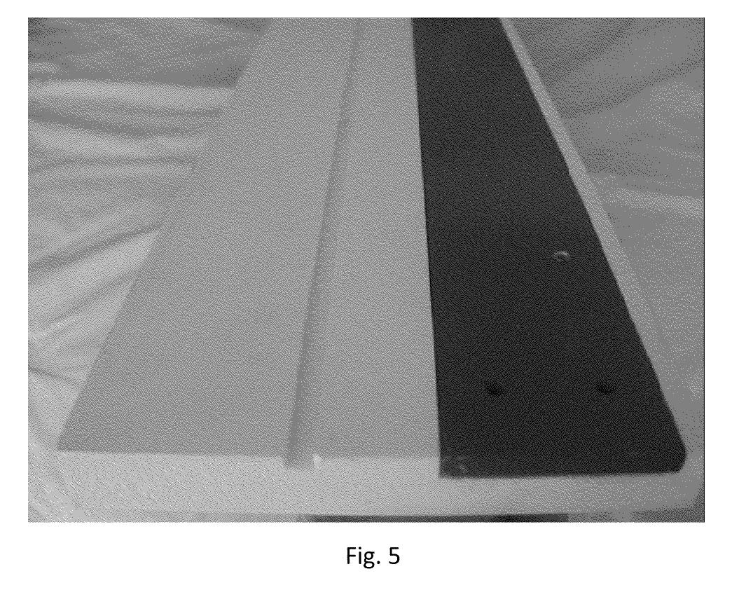

FIG. 6 is a close up view of the fastener holes of a vertical member of the exoskeleton of the present invention;

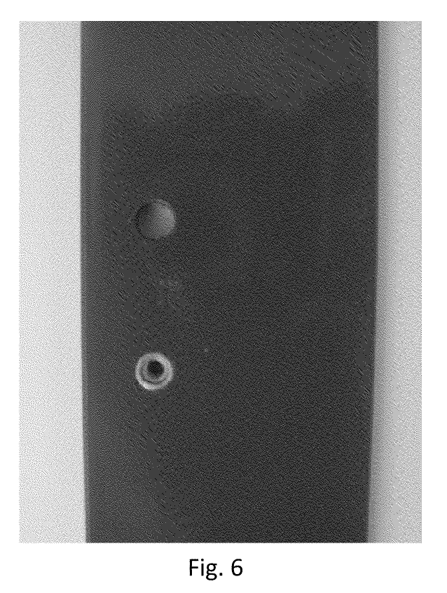

FIG. 7 is a close up view of the hinge of a vertical member of the exoskeleton of the present invention; and

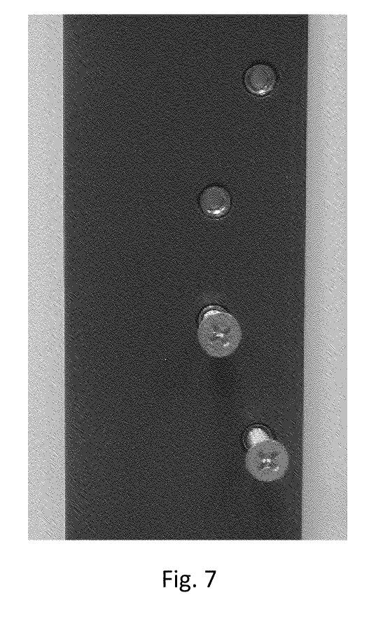

FIG. 8 is a close up view of the deadbolt bore of a vertical member of the exoskeleton of the present invention.

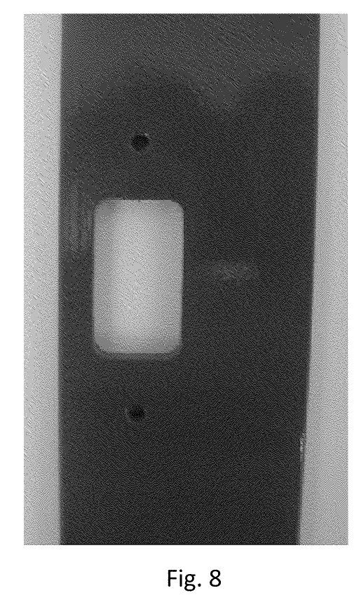

### DETAILED DESCRIPTION

A door jamb having a composite design, its principal structural members are steel and extruded and machined PVC lumber stock, all assembled with stainless steel fasteners is provided.

The door jamb of the present invention bears a conventional outward appearance, but underneath lies a unique steel exoskeleton which is machined in order to mount it to the home's frame first, then for the door to be mounted to it. This design element harkens back to the days when any carpenter worth his salt would set about the task of installing a door by first constructing a dimensionally perfect opening for it, then hanging the door within the resulting space. The door jamb of the present invention defines this space with the perfect material for the task, which is steel. It is this steel exoskeleton which keeps the door opening within desired tolerances, regardless of outside temperature. This results in much greater latch and lock engagement, as well as significant energy savings from a properly sealed door.

Another benefit of the steel exoskeleton is that the threshold now becomes a serviceable component because the lower dimension and structural integrity of the door jamb of the present invention are rendered not by the threshold, but instead by its own sill crossmember/threshold receiver component. Replacing the threshold is accomplished simply by removing three screws, sliding the old one out, and sliding a new one in, while applying silicone caulking simultaneously.

In keeping with its design intent, the kits for the door jamb system of the present invention include only premium quality hinges and thresholds.

A list of components for the present invention is as follows:

| PERIMA-JAMB COMPONENTS | CODE | QTY | SPECS |
|---|---|---|---|
| EXO-SKELETON | | | |
| VERTICAL MEMBER - STRIKE SIDE | VM-SS | 1 | ¼″ × 2″ STEEL |
| VERTICAL MEMBER - HINGE SIDE | VM-HS | 1 | ¼″ × 2″ STEEL |
| HORIZONTAL MEMBER - HEADER | HM-HE | 1 | ¼″ × 2″ STEEL |
| HM - THRESHOLD RECEIVER | HM-TR | 1 | ¼″ × 2″ STEEL |
| EXO-SKELETON FASTENERS | ES-LB | 9 | ¼″ × 2″ LAG BOLTS |
| EXO-SKELETON WASHERS | ES-LW | 9 | ¼″ WASHER |
| JAMB APPLIQUES | | | |
| JAMB APPLIQUE - STRIKE SIDE | JA-SS | 1 | MACHINED PVC TRIM |
| JAMB APPLIQUE - HINGE SIDE | JA-HS | 1 | MACHINED PVC TRIM |
| JAMB APPLIQUE - HEADER | A-HE | 1 | MACHINED PVC TRIM |
| APPLIQUE FASTENER - STRIKE SIDE | AF-SS | 4 | 8/32 × ½″ FLAT PHILLIPS SS MS |
| APPLIQUE FASTENER - HINGE SIDE | AF-HS | 4 | 8/32 × 1″ FLAT PHILLIPS SS MS |
| APPLIQUE FASTENER - HEADER | AF-HE | 3 | 8/32 × ¾″ FLAT PHILLIPS SS MS |
| THRESHOLD | | | |
| THRESHOLD - THERMA-TRU | TH-TT | 1 | BRIGHT ALUMINUM FINISH |
| THRESHOLD WOOD SCREWS | TH-WS | 3 | #10 × 2″ PAN-HEAD PHILLIPS WOOD |
| OTHER ITEMS | | | |
| HINGE MOUNTING SCREWS | HI-MS | 12 | 10/24 × 1″ FLAT PHIL BRASS MS |
| STRIKE PLATE MOUNTING SCREWS | SP-MS | 2 | 8/32 × ½″ FLAT PHIL BRASS MS |
| DEADBOLT PLATE MOUNT. SCREWS | DP-MS | 2 | 8/32 × ½″ FLAT PHIL BRASS MS |
| WEATHERSTRIP | WS-TT | 3 | TT STANDARD DOOR WEATHERSTRIP - BROWN |

The benefit of the present invention is not only in its design, but in the method of installing the product.

Phase I—Rough Opening Preparation

The door jamb of the present invention requires only one condition for its proper installation and reliable performance; a true, properly sized, rough opening. This starts with an absolutely straight and level subfloor surface and ends when the diagonal measurements from opposing upper and lower corners are within ¼ of each other.

Phase II—Installing the Steel

Step A—Install the Threshold Receiver

1. Start by placing a straightedge against the inner-most wall surfaces on both sides of the door opening. Ensure that your straightedge is not against the baseboard or other finish trim. Mark a neat, thin line with a sharp pencil on the subfloor on the outside (of the house) edge of the straightedge.

2. Now, with a ruler make marks ¼″ towards the outside of the house from the line first drawn. Do this in the middle and at both ends of the door opening, then connect the lines with a straightedge. A straight, flat piece of wood cut to the proper length will work nicely for this if no other tool is available.

3. Place the Threshold Receiver (EXO-TR) member on the floor with the second line drawn being on the inside of the house side of the steel. Carefully mark the exact center point of each of the three pre-drilled holes with a sharp fine point marker. Next, impress a small hole into the subfloor material in the center of each of the three marks you just made. A steel center-punch tool is ideal for this, but a framing nail can also work well enough here for this task. Using a ⅛″ drill bit, drill holes in the depressions made by the three center punch marks, keeping the drill plumb as you do so.

4. Install the 3 pan-head wood screws (EXO-TRF) through the Threshold Receiver and into the subfloor. Do not over-tighten these screws. The Threshold Receiver is now installed.

Step B—Install the Hinge Side Member

1. Determine which side of the rough opening the door will be hinged upon.

2. Place the Hinge Side Member (EXO-HS) on top of the Threshold Receiver and fasten the corner connector with the machine screws. Place a 6′ level along the outside of the house edge of the steel and render it to a plumb position.

3. While keeping the steel plumb, mark the exact center of the top pre-drilled hole onto the stud behind it, make a center-punch impression, and using a ¼″ drill bit, drill a hole at least 1½″ deep into the stud. Install (1) ¼″×2″ lag bolt (EXO-F) and (1) ¼″ washer (EXO-W) through the steel and into the stud until the materials just touch one another. Do not over-tighten. These fasteners will be fully tightened in a later step.

4. Repeat step 3 for the three remaining pre-drilled holes in the steel, taking care not to over-tighten any of the lag bolts or bend the steel. The Hinge Side Member is now installed.

Step C—Install the Strike Side Member

1. The opposing side of the door opening will be the strike side.

2. Place the Hinge Side Member (EXO-HS) on top of the Threshold Receiver and fasten the corner connector with the machine screws. Place a 6′ level along the outside of the house edge of the steel and render it to a plumb position.

3. While keeping the steel plumb, mark the exact center of the top pre-drilled hole onto the stud behind it, make a center-punch impression, and using a ¼″ drill bit, drill a hole at least 1½″ deep into the stud. Install (1) ¼″×2″ lag bolt (EXO-F) and (1) ¼″ washer (EXO-W) through the steel and into the stud until the materials just touch one another. Do not over-tighten. These fasteners will be fully tightened in a later step.

4. Repeat step 3 for the remaining three pre-drilled holes in the steel, taking care not to over-tighten any of the lag bolts, or bend the steel. The Strike Side Member is now installed.

Step D—Install the Header Member

1. Locate the (4) Machine Screws provided to fasten the Header Member (EXO-HE).

2. Hold the Header Member in position against one of the upper corners of the Vertical Members and install (2) fasteners through the Header Member into the threaded fastening component on the upper corners of the Vertical Members.

3. Install the other (2) fasteners on the opposing side. The Header Member is now installed.

Step E—Aligning the Steel

1. Using a 6′ level, adjust the lag bolts on either of the two vertical members so that each piece of steel is perfectly plumb. Shim as necessary to ensure that you don't bend the steel or otherwise deform it as you do this. Use the 6′ level as a straightedge along the inner surfaces of the steel to ensure that it is straight. It is the opposing outward forces of the lag bolt fasteners that ultimately serve to keep the steel securely in position.

2. As you adjust the unit for plumb by tightening and/or loosening the lag bolts, ensure that the opening remains square by intermittently taking diagonal measurements from opposing upper and lower corners. The steel is “dialed in” when these measurements are within 1/16″ of each other.

3. Using two pieces of ordinary string, make an “X” across the plane created by the outer edges of the steel by taping them onto opposing upper and lower corners with masking or duct tape. The two pieces of string should just be touching each other at the point where they intersect.

4. This is the single most important part of the installation because every step that follows is dependent upon the proper alignment of the steel. So, ensure that both horizontal steel members are dead level. Then, ensure that both vertical steel members are dead plumb on both axises (meaning side to side across the door opening and also front to back within the stud wall). Once these tolerances have been achieved, the steel is now properly installed.

Phase III—Installing the Threshold

Step A—Threshold Preparation

1. Prepare the threshold for installation by first removing the (4) Phillips head adjustment screws in the adjustable sill piece of the threshold. Then, carefully pry off the adjustable sill piece.

Step B—Caulking Application

1. Apply a generous bead (about ¼″) of silicone caulking 1″ in from the front of the house across the entire door opening onto the subfloor. Apply another bead of caulking 2½″ in from the front of the house across the door opening onto the subfloor.

2. Apply a generous bead of silicone caulking along the inside bottom edges of the wall framing behind the steel, being careful not to fill any of the space within the inside of the steel with excess caulking. This is imperative because the threshold is designed to fit snugly into the width created by the steel.

Step C—Threshold Installation

1. Looking down upon the subfloor, orient the Threshold properly and place it into position on the subfloor so that the bottom Threshold Receiver Member interlocks with the groove cut into the bottom of the Threshold.

2. Install the (3) Pan Head Wood Screws (TH-F) provided to fasten the Threshold to the subfloor. Tighten securely, taking care not to over-tighten.

3. Carefully reinstall the adjustable sill piece into the threshold and replace the (4) adjustment screws until they are snugly seated, allowing for later adjustment.

Phase IV—Installing The Trim

Step A—Install the Header Applique

Step B—Install the Hinge Side Applique

Step C—Install the Strike Side Applique

Phase V—Mounting The Door

Step A—Preparing the Door Slab for mounting

1. Locate the hinges included in the kit along with all (12) of the flat-head Phillips Door Slab Hinge Mounting Screws (DS-F).

2. Using a punch, a nail set, or some other similar tool (again, a framing nail will suffice) gently tap out the hinge pins from the hinges. Do this for all the hinges. Make two groups of hinge halves, one with three hinge pin tubes for the door slab and another with two hinge pin tubes, which will go on the jamb.

3. Set the door slab on some sawhorses with the inside surface facing up.

4. Place one of the pre-selected hinge halves (the ones with three hinge pin tubes) so that the hinge pin tubes are on top and install the Door Slab Hinge Mounting Screws (DS-F). Do not over-tighten these as doing so will strip out the internal door slab frame within the door, thus comprising the integrity of the fastening. In fact, when mounting the door to the jamb, it may prove helpful if these screws are a full turn or two away from snug, thus allowing these hinge halves some movement to aid in rejoining the hinges.

5. Repeat step 4 for the other two hinges.

Step B—Preparing the Door Jamb for mounting

1. Locate the (3) pieces of weatherstripping material provided with the kit. Install these by placing the thin, finned edge of the weatherstrips into the slotted receivers on the Appliques.

2. Locate the remaining hinge halves from Step A, above.

3. Locate all (12) of the flat-head Phillips Machine Screws (PJH-F).

4. Orient one of the hinge halves so that the hinge pin tubes are on the inside of the house. Place this into one of the pre-mortised hinge seats on the Hinge Side Applique Member.

5. Install the Door Jamb Hinge Mounting Screws (PJH-F) through the hinge and into the threaded receiver of the steel beneath. Do not over-tighten these as doing so will strip out the threads of the Machine Screws or the threaded receivers, thus comprising the integrity of the fastening.

Step C—Attaching the Door Slab to the Door Jamb

1. Align the door slab hinge pin tubes within the door jamb hinge pin tubes on all three hinges and gently wiggle the door slab until all three hinges come into alignment.

2. Gently close the door into the door jamb and hold the door slab in place while placing all (3) hinge pins back into the hinges by gently tapping them into place with a finish hammer.

3. Tighten all of the hinge screws on the door slab until they are ½ of a turn tighter than snug, while also being careful not to over-tighten them, which would comprise the integrity of the fastening.

Phase VI—Installing the Lockset

Step A—Installing the Door Knob and Deadbolt (if applicable).

1. Follow the lockset manufacturer's instructions for installing the door knob and deadbolt.

Step B—Installing Strike Plate and Deadbolt Plate

1. Locate the (2) fasteners for the Strike Plate (SP-F), the (2) fasteners for the Deadbolt Reinforcing Plate (DR-F) and the (2) fasteners for the Deadbolt Finish Plate (DP-F) included in the kit.

2. Place the Strike Plate included with your lockset into the Strike Plate mortise. Install the (2) Strike Plate Fasteners (SP-F) until they are ¼ turn beyond snug. Do not over-tighten these as doing so will strip out the threads of the Machine Screws or the threaded receivers, thus comprising the integrity of the fastening.

3. Place the Deadbolt Finish Plate included with your lockset into the Deadbolt Finish Plate mortise. Attach with the (2) Deadbolt Finish Plate Fasteners (DF-F).

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

1. A door jamb comprising:
a threshold receiver, the threshold receiver being attached to a subfloor;
an exoskeleton, the exoskeleton further comprising a hinge side member, a strike side member, and a header member, wherein the hinge side member is attached to a first side of the threshold member and the strike side member is attached to a second side of the threshold receiver, and wherein the header member is positioned between an upper corner of the hinge side member and an upper corner of strike side member; and
a plurality of appliqués, the plurality of appliqués further comprising a hinge side appliqué, a strike side appliqué, and a header appliqué, wherein the hinge side appliqué is attached to the hinge side member, the strike side appliqué is attached to the strike side member, and the header appliqué is attached to the header member.

2. A method of installing a door jamb comprising:
preparing an opening for the door jamb;
attaching a threshold receiver to a subfloor;
attaching a hinge side member to a first side of the threshold receiver;
attaching a strike side member to a second side of the threshold receiver;
attaching a first end of a header member to an upper corner of the hinge side member;
attaching a second end of the header member to an upper corner of the strike side member;
aligning the hinge side member, the strike side member, and the header member within the door jamb opening;
attaching a threshold to the threshold receiver;
attaching a hinge side appliqué to the hinge side member;
attaching a strike side appliqué to the strike side member;
attaching a header appliqué to the header member
attaching a first plurality of hinge halves to a door;
attaching a second plurality of hinge halves to the hinge side appliqué; and
connecting the first plurality of hinge halves to the second plurality of hinge halves.
